(19) United States
(12) Patent Application Publication
(10) Pub. No.: US 2026/0350004 A1
(43) Pub. Date: Nov. 5, 2026

(54) Auto Adjustable LOB Prefetch Buffer For Medium-Size Value LOBs

(71) Applicant: Oracle International Corporation, Redwood Shores, CA (US)

(72) Inventors: Jose Omar Alvizo Flores, Foster City, CA (US); Zhen Hua Liu, San Mateo, CA (US)

(21) Appl. No.: 19/195,647

(22) Filed: Apr. 30, 2025

(51) Int. Cl. G06F 16/2453; G06F 16/22

(52) U.S. Cl. CPC G06F 16/24539; G06F 16/2219

(57) ABSTRACT

A value-based Large Object (LOB) access protocol is provided for improving the performance of LOB accesses when the whole LOB data is required on the client side and is needed only for reading purposes. The database client initiates access of a value-based large object (LOB) from a database server. The database client reads the LOB by receiving metadata for the LOB from the database server, wherein the metadata includes a LOB length value indicating a size of the LOB, automatically setting a LOB prefetch buffer size based on the LOB length value, and allocating memory for a LOB prefetch buffer based on the LOB prefetch buffer size. After allocating memory for the LOB prefetch buffer, the database client receives LOB content data for the LOB into the LOB prefetch buffer.

### FIELD OF THE INVENTION

The present invention relates to improving the performance of querying medium-sized value-based large objects (LOBs) when the entire LOB data is required on the client side.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

A relational database management system (RDBMS) controls the storage, organization, and retrieval of data stored in relational databases located at one or more database servers. The database server(s) may be interconnected by a network, which may also connect one or more clients (e.g., workstations, personal computers, or remote computing terminals). Clients may submit statements via the network to perform various tasks in a relational database. There are different types of statements to perform the various tasks in the relational database. For example, clients may manage database objects, such as tables, views, etc., using data definition language (DDL) statements (e.g., create schema objects, alter schema objects, drop schema objects, grant and revoke privileges, etc.) that result in data dictionary property change(s). As another example, clients may access data stored in the database schema objects (e.g., tables, views, etc.) using structured query language (SQL) query statements (e.g., SELECT SQL statements).

Due to the increasing number of content-rich applications, an increasingly common data type used to store large amounts of semi-structured and unstructured data in relational databases is the Large Object (LOB) data type. LOB data types in SQL were initially designed to cover large data objects having a size ranging from megabytes to terabytes. A LOB data type column can store up to terabytes of data in the RDBMS, contrasting with the standard VARCHAR and VARCHAR2 data types, which can only store up to 4 KB and 32 KB, respectively. Thus, LOBs are optimized for random reads and writes on large-sized data.

Conventionally, accessing LOB data stored within a relational database system is via an approach hereinafter referred to as “reference-based” access. This means a locator is sent to the client, and the client can access the LOB data in pieces using the locator as a reference to the LOB data. For example, reference-based access of LOB data uses a lob locator that includes information generated to provide a client with a reference to a storage location of the LOB data so that the client may access and retrieve the large amount of data in multiple accesses-unlike accessing the other data type, such as INT, CHAR, VARCHAR, VARCHAR2, which returns the actual data to the client, not a reference to a storage location of the data. This protocol is useful in cases where the LOB data is large and the whole LOB data is not required.

Recently, there has been an increasing number of LOB use cases where a user attempts to use LOBs similar to a large varchar/raw data type because the user cannot guarantee that all of their data will fit into the varchar/raw (e.g., 32 KB max) columns. There are cases, such as JavaScript Object Notation (JSON) and VECTOR data, where the data is not small enough to be stored as a scalar but is not large enough to warrant the price of using the LOB infrastructure. In other words, users want varchar/raw kind of semantics and performance but are forced to use LOBs because of the size limitations of varchar/raw. The user essentially wants LOBs that behave similarly to a large varchar and have fetch performance on par with varchar/raw. This is the Medium size Object (MOB) use case. As RDBMSs are being leveraged to support NoSQL-style applications that store MOBs inside LOB columns, the current RDBMS method of using LOB locators for accessing the LOB columns is expensive and cumbersome.

To mitigate these problems on the server side, the value-based LOB concept was introduced. Value-based LOBs help determine if the LOB is being accessed for reading purposes and improve the server's performance. Value-based LOBs are described in further detail in U.S. Pat. No. 11,372,859, entitled “Efficiently Supporting Value Style Access of MOBs Stored in LOB Column by Providing Value Based Semantics for LOBs in RDBMS,” the contents of which are incorporated by reference for all purposes as if fully set forth herein. Nevertheless, the value-based LOB concept does not mitigate problems on the client side, such as mismatches between LOB prefetch buffer sizes to the LOB data size and multiple round trips being required to read a value-based LOB.

To avoid round trips to the server, the customer can set the LOB prefetch size to get all or part of the data in the prefetch buffer. However, the LOB prefetch infrastructure is rigid. If the customer sets 1 MB for the LOB prefetch buffer, then that is exactly the memory size allocated for the buffer. There is no flexibility. This causes two problems: (1) if the data size is small, then the client wastes memory by allocating too much memory to the prefetch buffer, and (2) if the data size is large, then it is necessary to modify the application to receive the entire LOB data without multiple round trips to the server. Hence, currently, there is no flexibility with the LOB prefetch buffer.

### BRIEF DESCRIPTION OF THE DRAWINGS

In the drawings:

FIG. 1 is a block diagram illustrating a database system with large object storage in accordance with an embodiment.

FIG. 2A is a block diagram illustrating a database client initiating access to a LOB using a value-based LOB access protocol in accordance with an embodiment.

FIG. 2B is a block diagram illustrating a database client reading LOB data using a value-based LOB access protocol in accordance with an embodiment.

FIG. 3 is a flowchart illustrating the operation of a database client accessing a LOB using a value-based LOB access protocol in accordance with an embodiment.

FIG. 4 is a flowchart illustrating the operation of a database server providing access to a LOB using a value-based LOB access protocol in accordance with an embodiment.

FIG. 5 is a block diagram that illustrates a computer system upon which aspects of the illustrative embodiments may be implemented.

FIG. 6 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide a value-based Large Object (LOB) access protocol for improving the performance of LOB accesses when the whole LOB data is required on the client side and is needed only for reading purposes. The provided value-based LOB access protocol uses an auto-adjustable LOB prefetch buffer technique in the client to set the LOB prefetch buffer size based on the size of the LOB and to allocate an amount of memory to the LOB prefetch buffer based on the LOB prefetch buffer size. This allows the client to automatically set the LOB prefetch buffer size to a value that is adequate to store the entire LOB data in the LOB prefetch buffer. The entire LOB data is then sent from the server to the client, along with the locator.

The existing LOB prefetch protocol sends LOB metadata, including LOB length, chunk size, etc. The value-based LOB access protocol of the illustrative embodiments takes advantage of the LOB metadata, as it is sent first, by using the LOB length to determine the size of the LOB prefetch buffer for medium-size objects. Furthermore, in the prior approach, the customer must determine the LOB prefetch buffer size and set the LOB prefetch buffer size in the application code. With the provided value-based LOB access protocol, it is unnecessary to manually set the LOB prefetch buffer size because it is determined when receiving the LOB metadata.

This value-based LOB access protocol provides better memory management. Given that the LOB length is used to determine the LOB prefetch buffer size, the value-based LOB access protocol of the illustrative embodiments improves the memory footprint by avoiding allocating memory to the LOB prefetch buffer that will remain unused for smaller value-based LOBs. The value-based LOB access protocol also avoids extra round trips to the server. Because the entire LOB data is sent to the client side, it is not necessary to make additional requests for the LOB data between the client and the server; therefore, performance is improved. Furthermore, the value-based LOB access protocol improves the flexibility of developing application code because the customer does not need to change the LOB prefetch value.

### Value-Based Lob Access Protocol

As applications evolve to encompass increasingly richer semantics, they encounter the need to deal with the following kinds of data: simple structured data, complex structured data, semi-structured data, and unstructured data. The relational database model has been very successful at dealing with simple structured data—the kind that can be fit into simple tables. Object-relational features allow applications to deal with complex structured data—collections, references, user-defined types, and so on. Queueing technologies deal with messages and other semi-structured data. Large Object (LOB) data types are designed to support unstructured data.

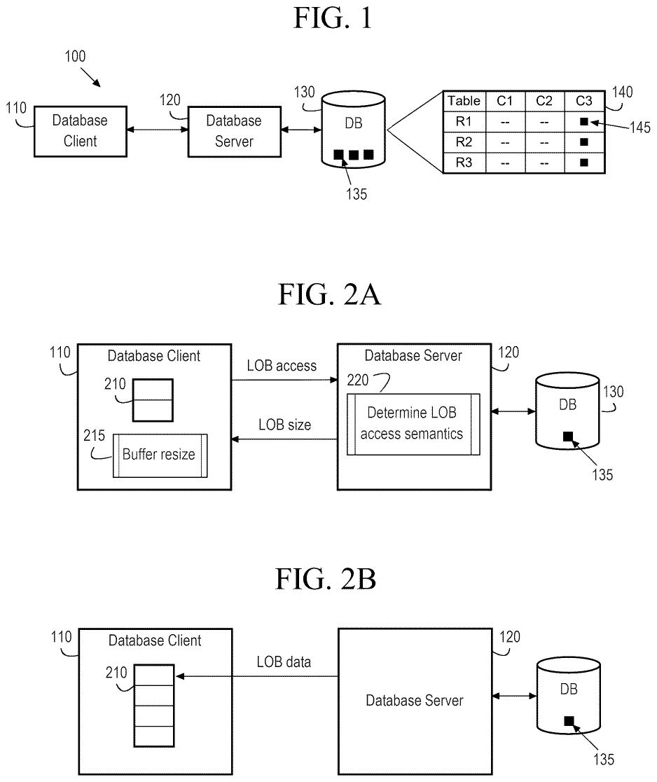

FIG. 1 is a block diagram illustrating a database system 100 with large object storage in accordance with an embodiment. Database client 110 accesses data in database 130 via database server 120. In the illustrative embodiments, the database system 110 is a relational database management system (RDBMS), also referred to herein as a “database system.” Database 130 includes Large Object (LOB) storage to store data objects, such as data object 135, which have the LOB data type. LOBs are database types that are used to store large amounts of data, such as text, images, sound files, or video files. Internal LOBs are stored in database table spaces and have transactional support (e.g., commit, rollback) in the database server 120. LOBs include, for example, binary LOBs (BLOBs), character LOBs (CLOBs), and national character LOBs (NCLOBs). External LOBs are operating system files outside the database tablespaces. Binary files (BFILEs) store data in external binary files. A BFILE can be in GIF, JPEG, MPEG, MPEG2, text, or other formats, for example.

Unstructured data objects, such as text, graphic images, still video clips, full motion video, and sound waveforms, tend to be large. A typical employee record may be a few hundred bytes, but even small amounts of multimedia data can be thousands of times larger. Some multimedia data may reside in operating system files, and it is desirable to access this data from the database. LOB data types can store unstructured data, are optimized for large amounts of data, and provide a uniform way of accessing large unstructured data within the database or outside of the database.

When a LOB column is inserted or updated, the database server 120 creates a LOB locator that points to the LOB data. This locator may be stored in the LOB column of the table. The actual LOB data can be stored either within the table (inline) or outside the table (out-of-line) in a separate storage area, depending on the size of the data and the configuration of the database table. To access or manipulate the LOB data, the LOB locator is used. The database server 120 provides various application programming interfaces (APIs) and SQL functions to read, write, and manipulate LOB data using the LOB locator.

In the depicted example shown in FIG. 1, database 130 includes table 140 having records stored in rows (e.g., R1, R2, R3) and data for the records stored in columns (e.g., C1, C2, C3). In this example, column C3 has a LOB data type, such as BLOB, CLOB, NCLOB, or BFILE. For instance, a database administrator can use the CREATE TABLE statement or an ALTER TABLE ADD column statement to create the LOB column C3. In the inline case, column content 145 stores the LOB data inline within the table 140. Thus, for row R1, the content of column C3 145 comprises the LOB data stored inline in the table. In the out-of-line case, column content 145 stores a LOB locator that points to the LOB data 135 in database 130. In another example, a LOB locator can point to LOB data that is external to the database, such as a BFILE data object.

As mentioned above, accessing LOB data stored within a relational database system is performed using a reference-based protocol, also referred to as a “reference-based semantic.” Reference-based access of LOB data uses a LOB locator that includes information generated to provide the client with a reference to a storage location of the LOB data so that the client can access and retrieve the LOB data. For a value-based LOB, a value-based semantic is used in which a LOB locator and a portion of the LOB data are returned from the server to the client if the size of the LOB is larger than the LOB prefetch buffer in the client. In a LOB prefetch protocol, the database server sends the following data to the database client: LOB length+LOB chunk size+LOB data+LOB locator. The LOB data sent to the database client is determined by the LOB prefetch buffer size set by the client. If the LOB length is greater than the LOB prefetch buffer in the client, then the database client accesses the LOB data in multiple round trips.

For some use cases, this LOB prefetch protocol is sufficient. For example, when a database client accesses a truly large data object, the client is expected to read the data in multiple round trips to the server. In other examples, the client may intend to read pieces of the LOB data without reading the entire LOB. However, for the Medium Object (MOB) case in which the LOB data is too large to use the VARCHAR or VARCHAR2 data type and the database client intends to read the entire LOB, the existing LOB prefetch protocol results in inefficient use of memory resources at the client and additional round trips to the server that could be avoided.

The illustrative embodiments provide a value-based LOB access protocol for improving the performance of LOB accesses when the whole LOB data is required on the client side and is needed only for reading purposes. FIG. 2A is a block diagram illustrating a database client initiating access to a LOB using a value-based LOB access protocol in accordance with an embodiment. Database client 110 initiates access of LOB 135 in database 130 by communicating with database server 120 to read the contents of LOB 135 into a LOB prefetch buffer 210 in database client 110. Database client 110 accesses a LOB using specialized APIs or SQL operations. Database client 110 can issue SQL commands to retrieve or manipulate LOBs, e.g., using SELECT or INSERT statements with LOB columns. Some databases provide APIs for client access to handle LOBs programmatically. Thus, database client 110 can initiate access to a LOB by submitting a SQL statement to database server 120 or by calling an API in database server 120. In FIG. 2A, the LOB prefetch buffer 210 has a default size or a size that was set for a previous LOB access.

In response to the database client 110 initiating access to LOB 135, the database server 120 uses logic 220 to determine the LOB access semantic to use for the LOB access (block 220). Logic 220 determines whether to use a reference-based LOB access semantic or a value-based LOB access semantic. In one embodiment, the database client may initiate LOB access by submitting a SQL query statement that includes a special construct that specifies that the LOB being accessed has a value-based LOB data type. An example of a special construction is “LOB_VALUE (lob_col_name),” where the lob_col_name parameter is the column name of the LOB and “LOB_VALUE()” is the special construct that the client includes in a select statement or WHERE clause of the SQL query statement to indicate to the database server that the client would like to access the LOB using the value-based LOB access protocol. For example, the SQL query statement may be illustrated as:
SELECT LOB VALUE (lob col name) FROM table T;

In another embodiment, the database client may initiate LOB access by referencing a LOB column in a table of database 130, and the database server 120 may look up the data type of the LOB column in a database dictionary in database 130. In another embodiment, the database server 120 may compare the LOB size to a predetermined threshold and use a reference-based LOB access semantic if the LOB size is greater than the predetermined threshold and a value-based LOB access semantic if the LOB size is less than or equal to the predetermined threshold.

If logic 220 in the database server 120 decides to use a reference-based LOB access semantic, then the database server 120 sends a LOB locator, as described above. In the depicted example, logic 220 decides to use a value-based LOB access semantic. In this case, the database server 120 sends metadata for the LOB that includes the LOB size to the database client 110. The database server 120 sends the metadata as a prefix to the LOB data. In one embodiment, the metadata also includes LOB chunk size. The metadata may also include a LOB locator in some implementations.

The database client 110 includes buffer resize logic 215 for resizing the LOB prefetch buffer 210 based on the LOB size received from the database server 120. If the current size of the LOB prefetch buffer 210 can accommodate the LOB size of LOB 135, then the buffer resize logic 215 does not resize the LOB prefetch buffer 210.

FIG. 2B is a block diagram illustrating a database client reading LOB data using a value-based LOB access protocol in accordance with an embodiment. In the depicted example, the buffer resize logic 215 in the database client 110 has determined that the LOB size is greater than the LOB prefetch buffer size. In this case, the buffer resize logic 215 sets the LOB prefetch buffer size based on the LOB size received from the database server 120. In some embodiments, the buffer resize logic 215 sets the LOB prefetch buffer size to a multiple of a predetermined amount of memory (e.g., 32 KB). In another embodiment, the buffer resize logic 215 sets the LOB prefetch buffer size to be equal to the LOB size.

In some embodiments, the database client 110 allocates memory in multiples of a predetermined amount of memory (e.g., 32 KB). The database client 110 then uses the following strategy: if LOB length <32 KB, then allocate 32 KB (level 1); if LOB length >32 KB and <64 KB, then allocate 64 KB (level 2); if LOB length >64 KB and <96 KB, then allocate 96 KB (level 3); and so on. In the example shown in FIG. 2A, the LOB prefetch buffer 210 may be 64 KB (2×32 KB), and the LOB length received from the database server 120 may be 120 KB. Therefore, in FIG. 2B, the database client 110 allocates 128 KB (4×32 KB) to the LOB prefetch buffer 210.

In some embodiments, the LOB prefetch buffer 210 is associated with a particular LOB column, such as column C3 in FIG. 1. The database client 110 maintains one LOB prefetch buffer 210 for all rows of the LOB column C3. In the example shown in FIG. 2A, the database client 110 may initiate access to row R1 of column C3, and the content of column C3 at row R1 may include a LOB locator pointing to a first LOB in database 130. The database client 110 can initiate access of a row by fetching rows with LOB columns using a SELECT statement specifying the desired rows using a WHERE statement with conditions or row identifiers. The logic 220 in the database server decides to use a value-based LOB access semantic and sends the LOB size of the first LOB to the database client. The buffer resize logic 215 may determine that the LOB prefetch buffer size is sufficient for reading the first LOB. For instance, the LOB size of the first LOB may be 62 KB, and the LOB prefetch buffer 210 may be 64 KB. Then, in FIG. 2A, the database client 120 initiates access to row R2 of column C3, and the content of column C3 at row R2 may include a LOB locator pointing to a second LOB in database 130. The logic 220 in the database server decides to use a value-based LOB access semantic and sends the LOB size of the second LOB to the database client. Buffer resize logic 215 in the database client 110 may decide to resize the LOB prefetch buffer 210 based on the LOB size of the second LOB. For instance, the LOB size of the second LOB may be 120 KB, which is greater than the size of the LOB prefetch buffer 210 in FIG. 2A. Therefore, in FIG. 2B, the buffer resize logic 215 would resize the LOB prefetch buffer based on the LOB size of the second LOB.

Reducing the size of a LOB prefetch buffer would involve freeing the old LOB prefetch buffer and reallocating memory for a new smaller LOB prefetch buffer. There may be implementations where this is necessary or desirable; therefore, in one embodiment, the buffer resize logic 215 can decide to free the LOB prefetch buffer 210 and allocate memory for a new smaller LOB prefetch buffer if the pattern of LOB sizes indicates that the current LOB prefetch buffer size is too high, thus negatively affecting performance. However, in some embodiments, the buffer resize logic 215 increases the LOB prefetch buffer size if a LOB being accessed has a LOB length or size that exceeds the size of the LOB prefetch buffer but does not reduce the size of the LOB prefetch buffer.

Because the LOB prefetch buffer is associated with a LOB column, even if the database client accesses a LOB that is much smaller than the current LOB prefetch buffer size, it is possible that a subsequent LOB in the LOB column will be even larger than the current LOB prefetch buffer size. Thus, in the example above, after accessing the second LOB, the database client 120 may initiate access to row R3 of column C3, and the content of column C3 at row R3 may include a LOB locator pointing to a third LOB with a LOB size of 30 KB; however, the database client 120 may then initiate access to row R4 of column C3, and the content of column C3 at row R4 may include a LOB locator pointing to a fourth LOB with a LOB size of 250 KB. It would be counterproductive to reduce the size of the LOB prefetch buffer to read the third LOB and then to increase the size of the LOB prefetch buffer to read the fourth LOB.

In FIG. 2B, after resizing the LOB prefetch buffer 210 and allocating memory to the LOB prefetch buffer based on LOB prefetch buffer size, the database client receives the LOB data from the database client 120 and stores the LOB data in the LOB prefetch buffer 210. Because of the value-based LOB access protocol of the illustrative embodiments, the database client 110 sets the LOB prefetch buffer size to a value that is appropriate for the LOB being accessed, such as LOB 135 in FIG. 2B. Therefore, the database client 110 does not allocate too much memory to the LOB prefetch buffer, while also allocating enough memory to the LOB prefetch buffer to avoid additional round trips to the database server 120 to receive the LOB data.

In some embodiments, the same LOB buffer can be used several times. Thus, there could be cases where the LOB prefetch buffer was already allocated. For such cases, the following rules may be followed:
1. The client obtains the current prefetch buffer level and the requested buffer level:
   a. current prefetch buffer level=(LOB length size/32768)+1
   b. requested prefetch buffer level=((current LOB prefetch size−1)/32768)+1
2. If the current prefetch buffer level is less than the requested prefetch buffer level or if (current prefetch buffer level-required prefetch buffer level) is greater than or equal to 4, then the client resizes the LOB prefetch buffer.
   Thus, in this embodiment, the client resizes the prefetch buffer if the current prefetch buffer level is too low or if the current prefetch buffer level is four levels too high.

### Enabling or Disabling the Value-Based Lob Access Protocol

The value-based LOB access protocol of the illustrative embodiments may be enabled by default for certain data types, such as JSON and VECTOR types. In some embodiments, it may be possible to disable the value-based LOB access protocol using a statement, such as: OCI_ATTR_VBL_SEND_ALL_LOB_DATA. The following is code for getting an attribute:

```
OCIDefineByPos(stmthp, &defn2p, errhp, (ub4) 1,
      (dvoid *) &jsond, (sb4) −1,
      DTYJSON, (dvoid *) &ind, (ub2 *) 0, (ub2 *)0,
      (ub4) OCI_DEFAULT);
status = OCIStmtExecute(svchp, stmthp, errhp, (ub4) 0,
        (ub4) 0, (CONST OCISnapshot *) NULL,
        (OCISnapshot *) NULL, OCI_DEFAULT);
{
  boolean sendalldata;
  OCIAttrGet((dvoid *)defn2p, (ub4)OCI_HTYPE_DEFINE,
    (dvoid *) (&sendalldata) , (ub4 *) 0,
    (ub4) OCI_ATTR_VBL_SEND_ALL_LOB_DATA,
    (OCIError *)errhp));
}
```

The following is code for setting the attribute:

```
OCIDefineByPos(stmthp, &defn2p, errhp, (ub4) 1,
      (dvoid *) &jsond, (sb4) −1,
      DTYJSON, (dvoid *) &ind, (ub2 *) 0, (ub2 *)0,
      (ub4) OCI_DEFAULT);
{
  boolean sendalldata;
  OCIAttrSet((dvoid *)defn2p, (ub4) OCI_HTYPE_DEFINE,
    (dvoid *) (&sendalldata) , (ub4 *) 0,
    (ub4) OCI_ATTR_VBL_SEND_ALL_LOB_DATA,
    (OCIError *)errhp));
}
status = OCIStmtExecute(svchp, stmthp, errhp, (ub4) 0,
        (ub4) 0, (CONST OCISnapshot *) NULL,
        (OCISnapshot *) NULL, OCI_DEFAULT);
```

The database client can determine whether the adjustable LOB prefetch buffer protocol is enabled at the database client. The database client then sets the LOB prefetch buffer size and allocates memory in the database client for the LOB prefetch buffer in response to determining that the adjustable LOB prefetch buffer protocol is enabled at the database client.

### Procedural Overview

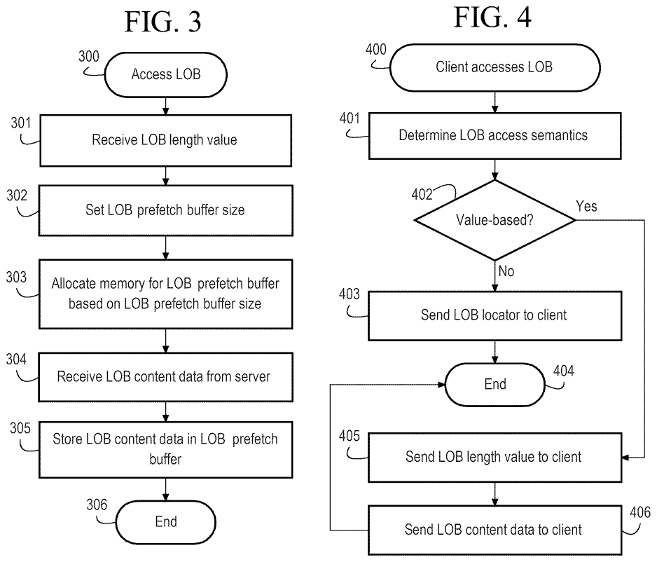

FIG. 3 is a flowchart illustrating the operation of a database client accessing a LOB using a value-based LOB access protocol in accordance with an embodiment. Operation begins when a database client accesses a LOB (block 300). The database client receives a LOB length (size) value from the database server (block 301). The database client sets the LOB prefetch buffer size based on the LOB length value (block 302). The database client then allocates memory for the LOB prefetch buffer based on the LOB prefetch buffer size (block 303). Then, the database client receives LOB content data from the server (block 304) and stores the LOB content data in the LOB prefetch buffer (block 305). Thereafter, the operation ends (block 306).

FIG. 4 is a flowchart illustrating the operation of a database server providing access to a LOB using a value-based LOB access protocol in accordance with an embodiment. Operation begins when a client accesses a LOB (block 400). The database server determines LOB access semantics (block 401). The database determines whether to use a value-based semantic (block 402). If the database determines not to use a value-based semantic (block 402: No), i.e., to use a reference-based semantic, the database server sends the LOB locator to the client (block 403). The database client can then access the LOB content using the LOB locator. Thereafter, the operation ends (block 404).

If the database server determines to use a value-based semantic (block 402: Yes), then the database server sends the LOB length to the client (block 405) and sends the LOB content data to the client (block 406). Thereafter, the operation ends (block 404).

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

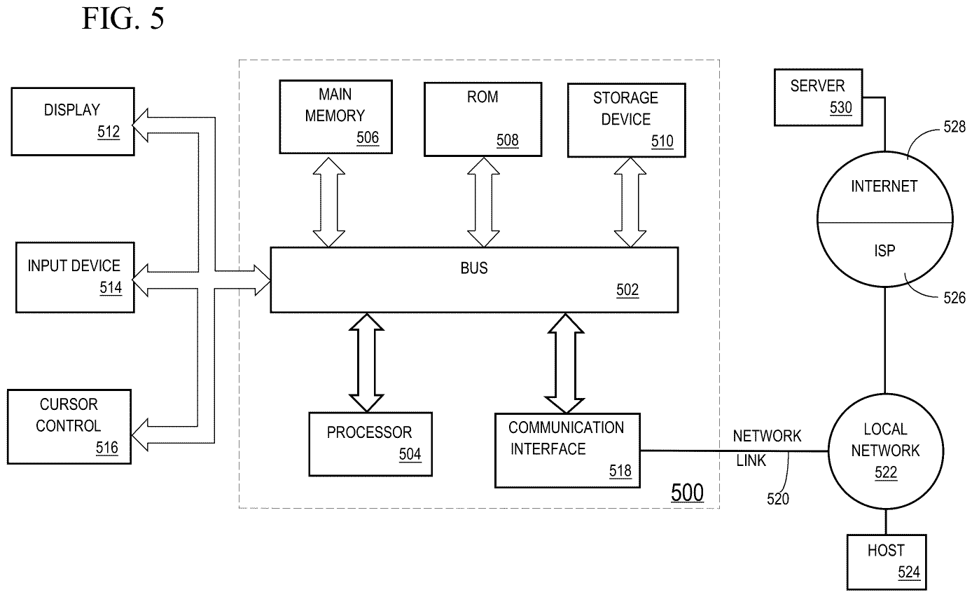

For example, FIG. 5 is a block diagram that illustrates a computer system 500 upon which aspects of the illustrative embodiments may be implemented. Computer system 500 includes a bus 502 or other communication mechanism for communicating information, and a hardware processor 504 coupled with bus 502 for processing information. Hardware processor 804 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Over View

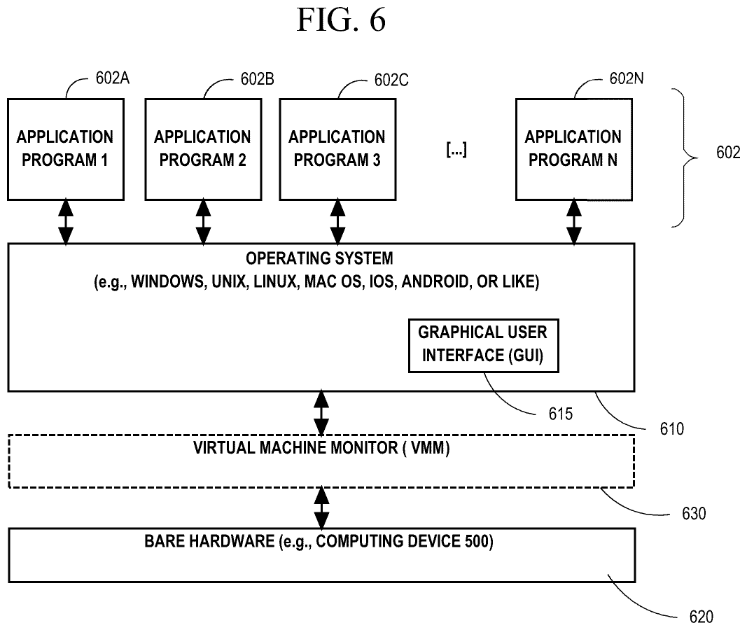

FIG. 6 is a block diagram of a basic software system 600 that may be employed for controlling the operation of computer system 500 upon which aspects of the illustrative embodiments may be implemented. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 600 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model that enables on-demand access to a shared pool of computing resources, such as computer networks, servers, software applications, and services, and that allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
initiating, by a database client, access of a large object (LOB) from a particular column of a table, the particular column having a LOB data type, from a database server, wherein the LOB is a value-based LOB;
reading, by the database client, the LOB using value-based semantics, comprising:
receiving metadata for the LOB from the database server, wherein the metadata includes a LOB length value indicating a size of the LOB;
automatically setting a LOB prefetch buffer size based on the LOB length value;
allocating memory for a LOB prefetch buffer based on the LOB prefetch buffer size; and
after allocating memory for the LOB prefetch buffer, receiving LOB content data for the LOB into the LOB prefetch buffer,
wherein the method is performed by one or more computing devices.

2. The method of claim 1, wherein initiating access of the LOB comprises specifying, by the database client, the value-based semantics for the access.

3. The method of claim 1, further comprising:
receiving the LOB content data for the value-based LOB prefixed with the metadata at the database client based on a determination, by the database server, that access of the LOB uses the value-based semantics.

4. The method of claim 3, wherein determining that access of the LOB uses the value-based semantics comprises determining one or more of:
the database client specifies access using the value-based semantics,
the database client references the LOB as a value-based LOB data type,
a data dictionary defines the LOB as a value-based LOB data type, or
the LOB length value is less than or equal to a predetermined threshold.

5. The method of claim 1, wherein:
initiating access of the LOB comprises referencing the LOB from a first row of the particular column,
the method further comprises:
referencing a second LOB from a second row of the particular column of the table;
receiving metadata for the second LOB from the database server, wherein the metadata includes a second LOB length value indicating a size of the second LOB;
determining that the second LOB length value is greater than the LOB prefetch buffer size; and
increasing the LOB prefetch buffer size based on the second LOB length value.

6. The method of claim 5, wherein the method further comprises allocating memory for the LOB prefetch buffer based on the increased LOB prefetch buffer size.

7. The method of claim 5, wherein the method further comprises reading, from the database server, LOB content data for the second LOB into the LOB prefetch buffer.

8. The method of claim 1, wherein:
automatically setting the LOB prefetch buffer size comprises determining a number of memory allocation units of a predetermined size required to store the LOB content data based on the LOB length value, and
allocating memory for the LOB prefetch buffer comprises allocating the number of memory allocation units.

9. The method of claim 1, wherein the LOB prefetch buffer size is greater than or equal to the LOB length value and the method comprises reading the entire LOB content data into the LOB prefetch buffer.

10. The method of claim 1, further comprising determining that the LOB length value is greater than a predetermined threshold, wherein setting the LOB prefetch buffer size and allocating memory in the database client for the LOB prefetch buffer are performed in response to determining that the LOB length value is greater than the predetermined threshold.

11. The method of claim 1, further comprising determining that an adjustable LOB prefetch buffer protocol is enabled at the database client, wherein setting the LOB prefetch buffer size and allocating memory in the database client for the LOB prefetch buffer are performed in response to determining that the adjustable LOB prefetch buffer protocol is enabled at the database client.

12. One or more non-transitory computer-readable media storing instructions which, when executed by one or more processors, cause:
initiating, by a database client, access of a large object (LOB) from a particular column of a table, the particular column having a LOB data type, from a database server, wherein the LOB is a value-based LOB;
reading, by the database client, the LOB using value-based semantics, comprising:
receiving metadata for the LOB from the database server, wherein the metadata includes a LOB length value indicating a size of the LOB;
automatically setting a LOB prefetch buffer size based on the LOB length value;
allocating memory for a LOB prefetch buffer based on the LOB prefetch buffer size; and
after allocating memory for the LOB prefetch buffer, receiving LOB content data for the LOB into the LOB prefetch buffer.

13. The one or more non-transitory computer-readable media of claim 12, wherein initiating access of the LOB comprises specifying, by the database client, the value-based semantics for the access.

14. The one or more non-transitory computer-readable media of claim 12, wherein the instructions further cause:
receiving the LOB content data for the value-based LOB prefixed with the metadata at the database client based on a determination, by the database server, that access of the LOB uses the value-based semantics.

15. The one or more non-transitory computer-readable media of claim 14, wherein determining that access of the LOB uses value-based semantics comprises determining one or more of:
the database client specifies access using the value-based semantics,
the database client references the LOB as a value-based LOB data type,
a data dictionary defines the LOB as a value-based LOB data type, or
the LOB length value is less than or equal to a predetermined threshold.

16. The one or more non-transitory computer-readable media of claim 12, wherein:
initiating access of the LOB comprises referencing the LOB from a first row of the particular column,
the instructions further cause:
referencing a second LOB from a second row of the particular column of the table;
receiving metadata for the second LOB from the database server, wherein the metadata includes a second LOB length value indicating a size of the second LOB;
determining that the second LOB length value is greater than the LOB prefetch buffer size; and
increasing the LOB prefetch buffer size based on the second LOB length value.

17. The one or more non-transitory computer-readable media of claim 16, wherein the instructions further cause allocating memory for the LOB prefetch buffer based on the increased LOB prefetch buffer size.

18. The one or more non-transitory computer-readable media of claim 16, wherein the instructions further cause reading, from the database server, LOB content data for the second LOB into the LOB prefetch buffer.

19. The one or more non-transitory computer-readable media of claim 12, wherein:
automatically setting the LOB prefetch buffer size comprises determining a number of memory allocation units of a predetermined size required to store the LOB content data based on the LOB length value, and
allocating memory for the LOB prefetch buffer comprises allocating the number of memory allocation units.

20. The one or more non-transitory computer-readable media of claim 12, wherein the LOB prefetch buffer size is greater than or equal to the LOB length value and the instructions further cause reading the entire LOB content data into the LOB prefetch buffer.
